(19) United States
(12) Patent Application Publication
(10) Pub. No.: US 2017/0280392 A1
(43) Pub. Date: Sep. 28, 2017

(54) FINE TIMING MEASUREMENT SIGNALING

(71) Applicant: Intel Corporation, Santa Clara, CA (US)

(72) Inventors: Jonathan Segev, Tel Mond (IL); Minyoung Park, Portland, OR (US); Shahrnaz Azizi, Cupertino, CA (US); Adrian P. Stephens, Cambridge (GB)

(21) Appl. No.: 15/083,057

(22) Filed: Mar. 28, 2016

(51) Int. Cl. H04W 52/02

(52) U.S. Cl. CPC H04W 52/0235

(57) ABSTRACT

This disclosure describes systems, methods, and devices related to fine timing signaling. A device may determine a first request to establish a fine timing measurement (FTM) session from a first device. The device may determine one or more FTM measurement exchanges with the first device based at least in part on the FTM session. The device may determine an FTM measuring period associated with the FTM session. The device may determine one or more wake-up packets based at least in part on the first request. The device may cause to send at least one of the one or more wake-up packets to the first device on a first channel.

### TECHNICAL FIELD

This disclosure generally relates to systems and methods for wireless communications and, more particularly, to fine timing measurement signaling.

### BACKGROUND

Advances in wireless communications require the use of efficient batteries to allow users to utilize their devices for longer times between recharges or replacement. The exchange of data in wireless communications consumes power and having repeated recharges or installation of dedicated power lines may result in a relatively negative user experience.

### BRIEF DESCRIPTION OF THE DRAWINGS

FIG. 1 depicts a network diagram illustrating an example network environment of fine timing measurement (FTM) signaling, in accordance with one or more example embodiments of the present disclosure.

FIG. 2 depicts an illustrative schematic diagram of conflicting durations of burst instances, in accordance with one or more example embodiments of the present disclosure.

FIG. 3 depicts an illustrative schematic diagram of an FTM procedure between an initiating device and a responding device without a low-power wake-up receiver, in accordance with one or more example embodiments of the present disclosure.

FIG. 4 depicts an illustrative schematic diagram of a low-power wake-up receiver (LP-WUR) for an FTM procedure, in accordance with one or more example embodiments of the present disclosure.

FIG. 5 depicts an illustrative schematic diagram of an FTM measurement period, in accordance with one or more example embodiments of the present disclosure.

FIG. 6A depicts a flow diagram of an illustrative process for FTM signaling, in accordance with one or more example embodiments of the present disclosure.

FIG. 6B depicts a flow diagram of an illustrative process for FTM signaling, in accordance with one or more example embodiments of the present disclosure.

FIG. 7 illustrates a functional diagram of an example communication station that may be suitable for use as a user device, in accordance with one or more example embodiments of the present disclosure.

FIG. 8 is a block diagram of an example machine upon which any of one or more techniques (e.g., methods) may be performed, in accordance with one or more example embodiments of the present disclosure.

### DETAILED DESCRIPTION

Example embodiments described herein provide certain systems, methods, and devices for providing signaling information to Wi-Fi devices in various Wi-Fi networks, including, but not limited to, the IEEE 802.11 family of standards.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

A location of a Wi-Fi device may be determined based at least in part on various measurements with respect to other devices in the range of the Wi-Fi device. The Wi-Fi device may perform a timing measurement procedure, known as fine timing measurement (FTM), in order to allow the Wi-Fi device to obtain its range to another device, such as an access point or an FTM responder. The FTM procedure is an IEEE 802.11 protocol introduced to support location determination based on range measurement to multiple known responding devices and execution of location determination techniques, for example, triangulation, trilateration, etc. The existing time of flight (TOF) protocol relies on the responding device transmitting one or more fine timing measurement frames during negotiated time windows called a burst. These time windows have a known duration and interval. The FTM procedure may determine the location of an initiating device (also known as a positioning device) based on time differences between various FTM frames sent and received between a responding device and the initiating device during a burst duration that may be determined by the FTM procedure. The burst duration may be a duration of each burst instance starting at the boundary of a burst period. That is, the burst duration may be a time duration within which one or more FTM frames may be sent to the initiating device. The burst period may be an interval from the beginning of one burst instance to the beginning of the following burst instance. For example, a responding device, such as an access point or an FTM responder, may utilize FTM frames to perform time measurements within the burst duration in order to determine the location of an initiating device.

The initiating device may simultaneously or at different times initiate a number of FTM sessions with multiple responding devices. The multiple responding devices may be operating at different channels and may not be synchronized with each other in order to minimize collisions. Consequently, the initiating device may have more than one ongoing FTM procedure instance at any given time as well as other activities asynchronous in nature to the FTM procedure on other channels. As a result, there may be conflicting FTM time windows of concurrent FTM instances between the initiating device and the one or more responding devices. As a result, the initiating device transmits an FTM trigger frame to each responding device to signal its availability on the respective channel associated with each responding device. However, the FTM trigger frame results in wasted “on channel time.” That is, utilizing an FTM trigger frame in that manner requires additional processing time from the initiating device and/or the responding device. Additionally, the active part of the burst duration where the FTM messaging is being sent and received, compared to idle time or processing time within a burst, may be disproportionate. That is, the active part of the burst duration may be small in comparison to overall burst size due to various reasons such as allowing for measurement frame generation and minimal spacing between frames agreed upon by the initiating device and the responding device, as well as prioritization for other types of traffic. As a result, the initiating device and/or the responding device may be in an active state for longer than necessary during FTM messaging resulting in higher power consumption.

Example embodiments of the present disclosure relate to systems, methods, and devices for FTM trigger frame signaling. In particular, lower energy consumption may be achieved by adding a low-power wake-up receiver (LP-WUR) to an initiating device to wake up the main radio system (e.g., IEEE 802.11 radio) of the initiating device based on receiving a wake-up packet from a responding device during the FTM procedure. The LP-WUR integrated in the circuitry of the initiating device may be configured to receive a wake-up packet as an indication that the radio system of the initiating device may need to be powered on in order to start receiving/sending data associated with the FTM procedure. The LP-WUR may be based on, but not limited to, “on-off keying” (OOK), amplitude shift keying (ASK) or frequency shift keying (FSK) for signaling, and characterized with a much lower power consumption compared to a normal IEEE 802.11 orthogonal frequency-division multiplexing (OFDM) receiver (e.g., an IEEE 802.11 receiver). The responding device may include a wake-up packet transmitter that generates a wake-up packet to be transmitted to the initiating device during the FTM procedure.

In one embodiment, the LP-WUR may improve the FTM procedure by eliminating the need for a trigger frame transmission by the initiating device. Consequently, the responding device may transmit an indication (e.g., a wake-up packet) prior to transmission of one or more FTM measurement frames to the initiating device. The indication may be transmitted by the responding device using a wake-up packet transmitter. Consequently, power consumption may be lowered by implementing the LP-WUR and may prevent the initiating device from utilizing excess processing power due to the trigger frame transmission.

Further, the active part of the burst duration may be reduced compared to the total burst duration because the initiating device may now receive the indication prior to the FTM measurement frame transmission rather than waiting on a channel associated with the responding device until being polled by the responding device for an incoming FTM measurement frame.

In one embodiment, utilizing a wake-up packet allows the FTM procedure to move from sending data (e.g., sending the FTM trigger frame) to signaling (e.g., sending a wake-up packet) and may provide further advantages because signals may be processed by a low-power receiver as opposed to the IEEE 802.11 receiver.

In one embodiment, the wake-up packet may include information associated with the FTM frame during the FTM procedure. For example, the wake-up packet may include timing information associated with the FTM procedure. For example, the wake-up packet may include a time when an FTM frame may be sent and/or received by the initiating device. The wake-up packet may include an agreed and expected periodic reception of additional wake-up packets. That is, the wake-up packets may be expected to be sent periodically by a responding device during a burst duration and/or a burst period. Each wake-up packet may be associated with a set of FTM frames used for FTM measurements. One possibility is that wake-up packet is periodically sent providing timing information of the FTM measurement frame transmission (e.g., time reference from wake-up packet to an FTM frame). Another possibility may be that the transmission timing of the wake-up packet itself signals the near transmission of the FTM frame, which may result in the device receiving the wake-up packet to move to an active mode, that is a full receive mode.

In one embodiment, the use of LP-WUR may allow for more accurate TOF measurement based on FTM measurement frames that are transmitted during pre-negotiated time windows. Since the FTM procedure is targeted to support location determination based on range measurement to multiple known responding devices and execution of trilateration, the FTM procedure is capable of operating in both the associated and unassociated modes; that is, when a device (e.g., an initiating device) is associated with a responding device or is unassociated with the responding device. These time windows may be made by asynchronous access points (APs) deployed over different channels. Furthermore, the initiating device may have other asynchronous and non-periodic activities such as data connectivity to one of these APs or another AP.

The above descriptions are for purposes of illustration and are not meant to be limiting. Numerous other examples, configurations, processes, etc., may exist, some of which are described in greater detail below. Example embodiments will now be described with reference to the accompanying figures.

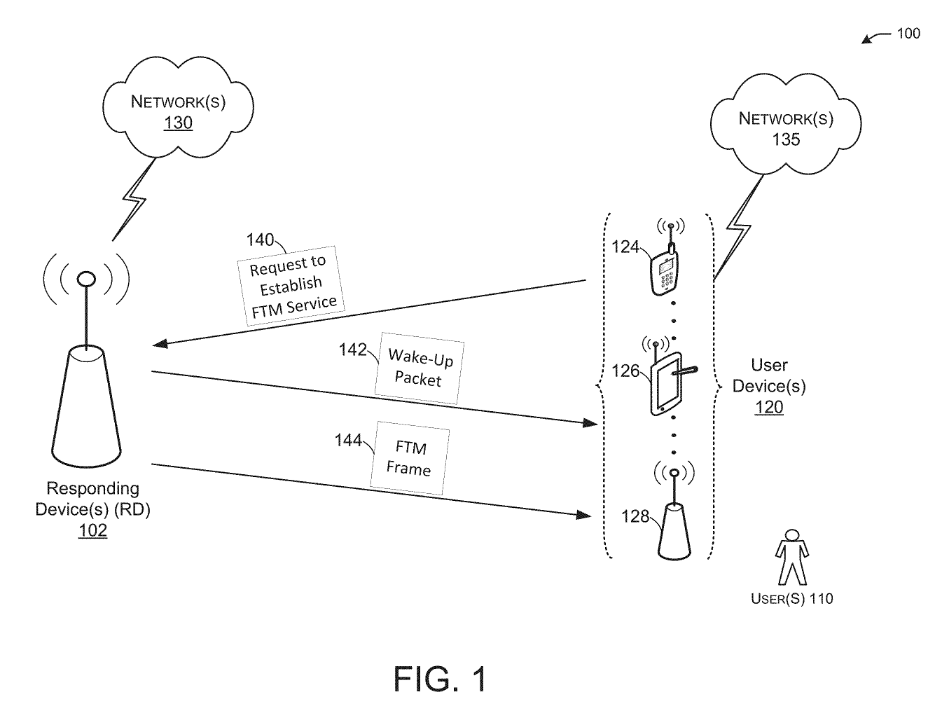

FIG. 1 is a network diagram illustrating an example network environment of fine timing measurement (FTM) signaling, according to some example embodiments of the present disclosure. Wireless network 100 may include one or more user devices 120 and one or more responding device(s) (RD) 102, which may communicate in accordance with IEEE 802.11 communication standards. The user device(s) 120 may be mobile devices that are non-stationary (e.g., not having fixed locations) or may be stationary devices.

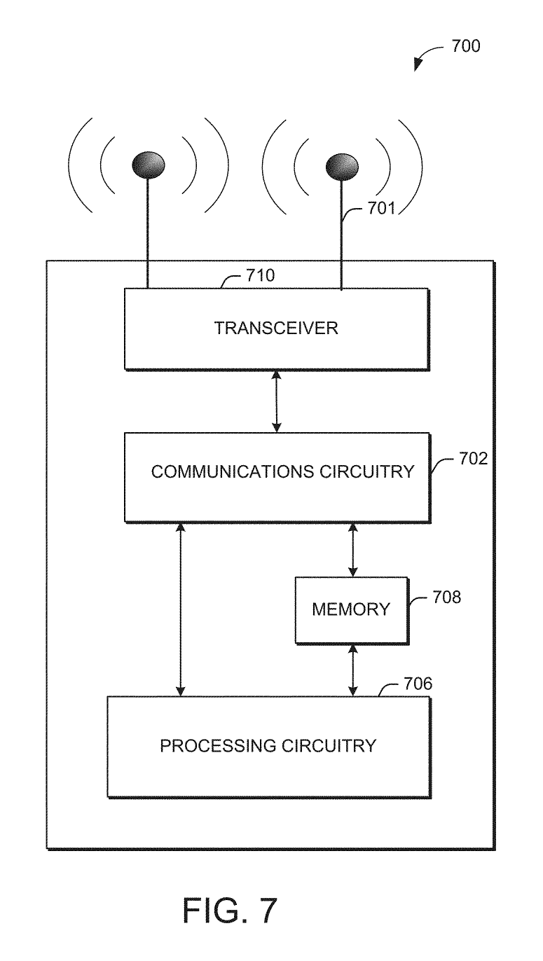

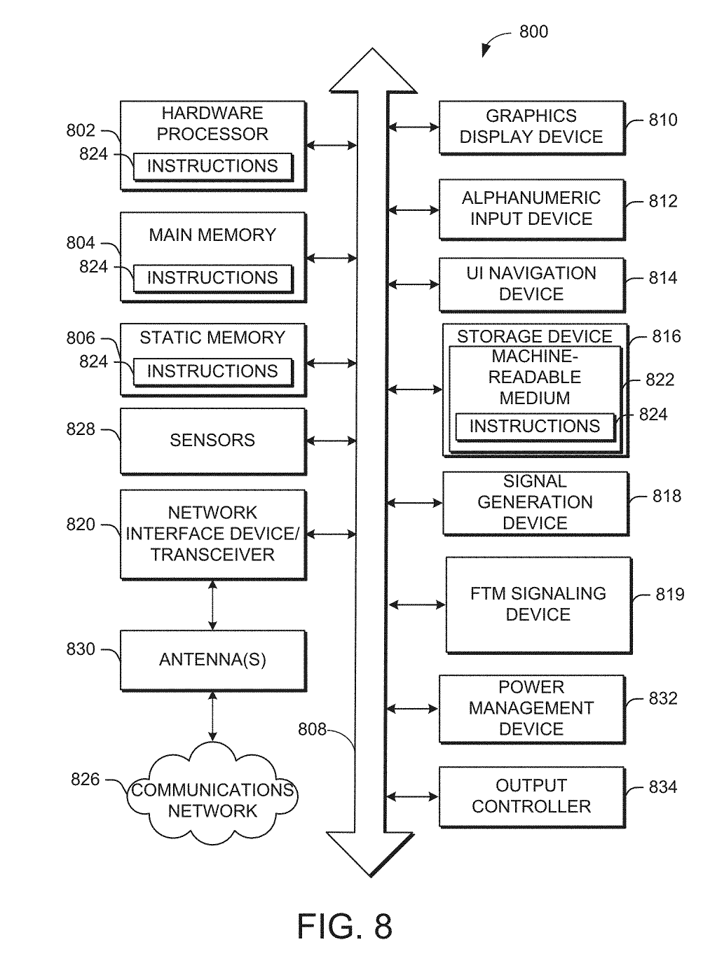

In some embodiments, the user devices 120 and the RD 102 may include one or more computer systems similar to that of the functional diagram of FIG. 7 and/or the example machine/system of FIG. 8.

One or more illustrative user device(s) 120 and/or the RD 102 may be operable by one or more user(s) 110. The user device(s) 120 (e.g., 124, 126, or 128) and/or the RD 102 may include any suitable processor-driven device including, but not limited to, a mobile device or a non-mobile (e.g., a static) device. For example, user device(s) 120 and/or the RD 102 may include a user equipment (UE), a station (STA), an access point (AP), a fine timing measurement (FTM) responder, a personal computer (PC), a wearable wireless device (e.g., a bracelet, a watch, glasses, a ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like.

Any of the user device(s) 120 (e.g., user devices 124, 126, 128), and the RD 102 may be configured to communicate with each other via one or more communications networks 130 and/or 135 wirelessly or wired. Any of the communications networks 130 and/or 135 may include, but are not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and the RD 102 may include one or more communications antennas. A communications antenna may be any suitable type of antenna corresponding to the communications protocols used by the user device(s) 120 (e.g., user devices 124, 126, and 128), and the RD 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., user devices 124, 126, 128), and the RD 102 may include any suitable radio and/or transceiver for transmitting and/or receiving radio frequency (RF) signals in the bandwidth and/or channels corresponding to the communications protocols utilized by any of the user device(s) 120 and the RD 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, 802.11ax), 5 GHz channels (e.g., 802.11n, 802.11ac, 802.11ax), 802.11 REVmc D5.0 Jan., or 60 GHz channels (e.g., 802.11ad). In some embodiments, non-Wi-Fi protocols may be used for communications between devices, such as Bluetooth, dedicated short-range communication (DSRC), ultra-high frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and a digital baseband.

With reference to FIG. 1, the one or more user devices 120 and/or the RD 102 may perform a fine timing measurement (FTM) procedure in order to allow at least one device to obtain its proximity and range to another device. The FTM procedure may determine the location of an initiating device (e.g., the user devices 120) based on time differences between various FTM frames sent and received between the initiating device and a responding device (e.g., the RD 102). For example, the RD 102, such as an access point or an FTM responder, may respond to an initiating device (e.g., the user devices 124, 126, and/or 128) by sending one or more FTM frames within a burst period and measuring the time associated with the one or more FTM frames in order to determine a time delay and consequently determine the location of the initiating device by utilizing techniques such as triangulation, trilateration, or the like. It is understood that the above descriptions are for purposes of illustration and are not meant to be limiting.

An FTM procedure may start with the initiating device (e.g., user device 124) sending a request to establish the FTM service (e.g., request to establish FTM service 140) to a responding device (e.g., the RD 102). During that portion of the FTM procedure, the initiating device may send an initial FTM request to the responding device, and the responding device may respond with an acknowledgement to the request. The responding device may then send a first FTM frame that includes, but is not limited to, information related to the burst period and the burst duration. The initiating device may then respond with an acknowledgement to the first FTM frame. Typically, the initiating device may wait until the burst period, and within the burst duration, the initiating device may send an FTM request trigger frame notifying the responding device that the initiating device is available on the channel associated with the responding device. The responding device may acknowledge the reception of the FTM request trigger frame by sending an acknowledgement message or frame to the initiating device. However, the FTM trigger frame results in wasted “on channel time.” That is, utilizing an FTM trigger frame in that manner requires additional processing time on the initiating device and/or the responding device.

In one embodiment, the initiating device (e.g., one or more user devices 120) may include, at least in part, a low-power wake-up receiver (LP-WUR) to wake up the main radio system (e.g., an IEEE 802.11 radio) within the initiating device based on receiving a wake-up packet (e.g., wake-up packet 142) from a responding device (e.g., the RD 102) during the FTM procedure. The LP-WUR is based on “on-off keying” (OOK), amplitude shift keying (ASK), or frequency shift keying (FSK) for signaling, and characterized with a much lower power consumption compared to a normal 802.11 OFDM receiver (e.g., an IEEE 802.11 receiver). The RD 102 may include a wake-up packet transmitter that generates the wake-up packet 142 to be transmitted to the initiating device during the FTM procedure.

In one embodiment, an LP-WUR may be used to allow for more accurate time of flight (TOF) measurement based on FTM measurement frames that are transmitted during the burst period and the burst duration. The LP-WUR may also lower the power consumption by the initiating device since the initiating device does not have to keep its radio system powered on (e.g., in an awake state) for the entire burst duration and/or the burst period. The initiating device may wake up its IEEE 802.11 radio after receiving the wake-up packet 142 based on information included in the wake-up packet 142. For example, the wake-up packet 142 may include timing information of when the initiating device may expect the FTM frame 144. The RD 102 may send the FTM frame 144 of one or more FTM frames that may be sent within the burst period to the initiating device (e.g., the user devices 124, 126, and/or 128). Based on the FTM procedure, the initiating device may determine its location. Furthermore, utilizing the LP-WUR may reduce the power consumption and allow for a longer operations period of the initiating device.

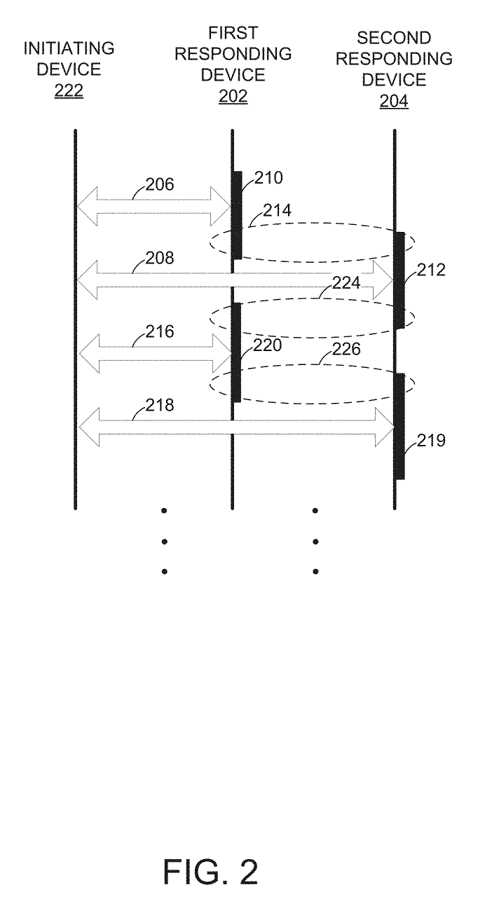

FIG. 2 depicts an illustrative schematic diagram of conflicting durations of burst instances, in accordance with one or more example embodiments of the present disclosure.

Referring to FIG. 2, there is shown an initiating device 222, a first responding device 202 and a second responding device 204. In this scenario, the initiating device 222 may have more than one ongoing FTM procedure instance in any given time on different channels. For example, an FTM frame exchange 206 may be performed between the initiating device 222 and the first responding device 202. The FTM frame exchange 206 may be associated with a scheduled burst instance 210 (including burst and burst duration). Additionally, an FTM frame exchange 208 may be performed between the initiating device 222 and the second responding device 204. The FTM frame exchange 208 may be associated with a scheduled burst instance 212. As shown in FIG. 2, there may be conflicting durations of burst instances (e.g., conflicting duration 214) between the burst instance 210 and the burst instance 212 because they may overlap in time. That is, when performing an FTM procedure with one responding device, a second FTM procedure with another responding device may conflict in time. Similarly, the FTM frame exchange 216 may be associated with a scheduled burst instance 220 and the FTM frame exchange 218 may be associated with a scheduled burst instance 219. As seen in FIG. 2, a conflicting duration 224 may be due to overlapping of the burst instance 220 and the burst instance 212. Similarly, a conflicting duration 226 may be due to overlapping of the burst instance 220 and the burst instance 219. The overlapping and conflicting durations shown in FIG. 2 may result in delays in the FTM measurements because the initiating device may be required to process additional messaging before acknowledging the reception of an FTM frame. Although FIG. 2 shows four FTM frame exchanges, it is understood that additional frame exchanges may exist based at least in part on the burst and/or the duration. The higher the number of FTM procedures performed between an initiating device and a plurality of responding devices, the higher the delays are due to additional processing time. It is understood that the above descriptions are for purposes of illustration and are not meant to be limiting.

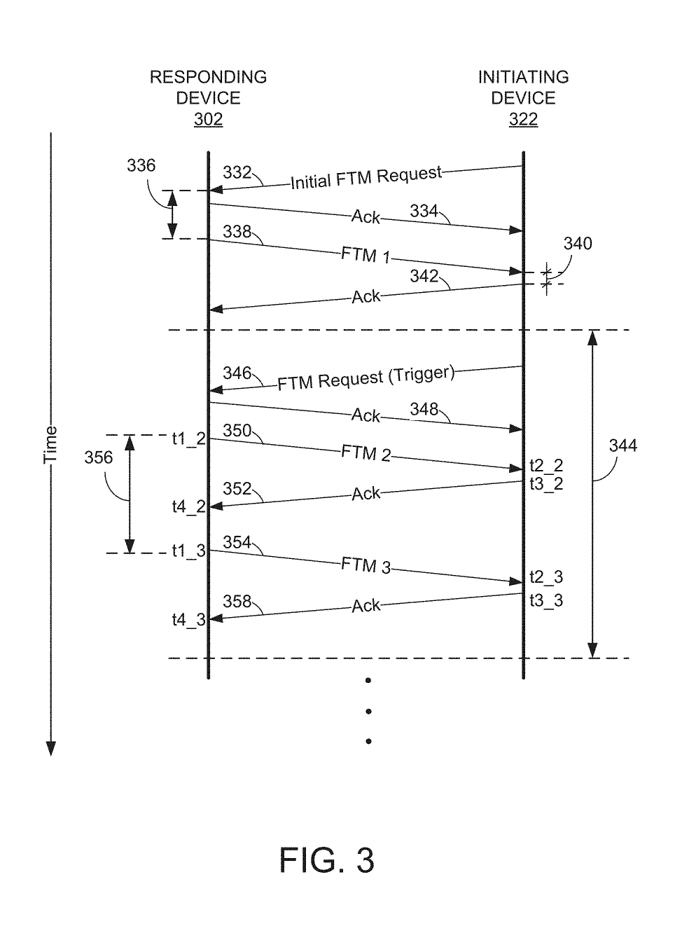

FIG. 3 depicts an illustrative schematic diagram of an FTM procedure between an initiating device and a responding device without an LP-WUR.

With reference to FIG. 3, there is shown an initiating device 322 and a responding device 302. The initiating device 322 and the responding device 302 may be involved in an FTM procedure in order for the initiating device 322 to determine, at least in part, its location. When performing the FTM procedure, the initiating device 322 may start the FTM procedure by sending an initial FTM request 332 to the responding device 302. The responding device 302 may send an acknowledgment (e.g., Ack 334) to the initiating device 322. The responding device 302 may determine a delay 336 before sending a first FTM frame 338 to the initiating device 322. The first FTM frame 338 may include information to inform the initiating device 322 of the burst duration and the burst period that the FTM procedure will be carried out for measuring delays in order to determine the location of the initiating device 322. When the initiating device 322 receives the first FTM frame 338, the initiating device 322 may process the first FTM frame 338, which may include a processing delay 340. Each time the initiating device 322 receives a frame from the responding device 302 and vice versa, a certain delay may increase the overall duration of the FTM measurements due to processing time for the received frames. The initiating device 322 may send an acknowledgment (e.g., Ack 342) in response to the received first FTM frame 338. The initiating device 322 and the responding device 302 may perform the FTM messaging in order to take time measurements within a burst duration 344. The initiating device 322 may wait until the burst period, and within the burst duration 344 the initiating device 322 may send an FTM request trigger frame 346 notifying the responding device 302 that the initiating device 322 is available on the channel associated with the responding device 302. The responding device 302 may acknowledge the reception of the FTM request trigger frame 346 by sending an acknowledgement (e.g., Ack 348) to the initiating device 322. The initiating device 322, in this scenario, may stay in the awake state until the reception of the second FTM frame 350. The responding device 302, at time t1_2 may send the second FTM frame 350 and start the time measurement. At time t2_2, the initiating device 322 may receive the second FTM frame 350. After a processing delay, at time t3_2, the initiating device 322 may send an Ack 352 to the responding device 302. The Ack 352 may be received by the responding device 302 at time t4_2. The responding device 302 may send a third FTM frame 354 at time t1_3 to the initiating device 322. The time duration 356 from time t1_2 to time t1_3 indicates the time duration between two consecutive FTM frames (e.g., the second FTM frame 350 and the third FTM frame 354). The third FTM frame 354 may be received by the initiating device 322 at time t2_3, and the initiating device 322 may respond by sending Ack 358 at time t3_3. The Ack 358 may be received by the responding device 302 at time t4_3. Having to send the FTM trigger frame 346 results in a wasted “on channel time.” That is, utilizing an FTM trigger frame 346 requires additional processing time from the initiating device and/or the responding device, which may result in additional power consumption. Implementing an LP-WUR on the initiating device 322, such that the initiating device 322 only wakes up at the specified time included in a wake-up packet sent from the responding device 302, may result in improved power consumption since the initiating device 322 wakes up before processing incoming messages as opposed to being in an awake state the entire time of the FTM procedure. It is understood that the above descriptions are for purposes of illustration and are not meant to be limiting.

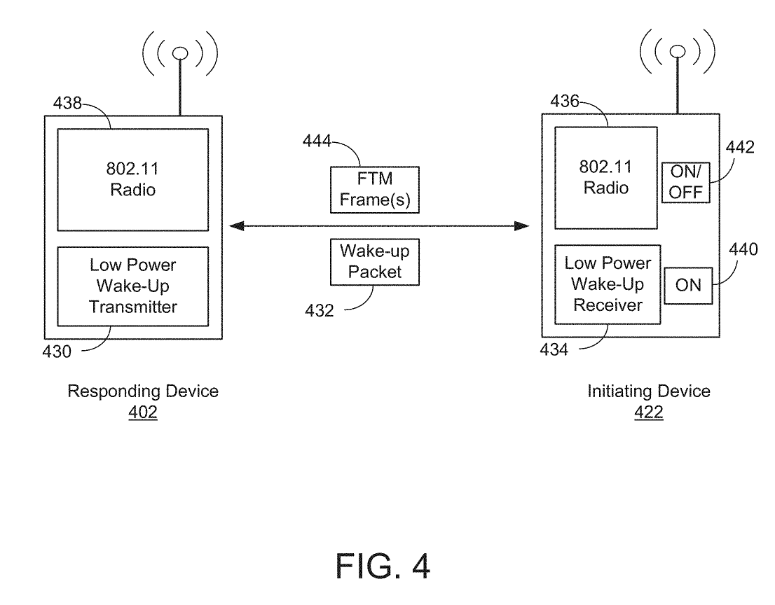

FIG. 4 depicts an illustrative schematic diagram of an LP-WUR for an FTM procedure, in accordance with one or more example embodiments of the present disclosure.

Referring to FIG. 4, there is shown a responding device 402 and an initiating device 422 involved in an FTM service session utilizing low-power wake-up signaling. The responding device 402 may utilize a low-power wake-up transmitter 430 to send a wake-up packet 432 to the low-power wake-up receiver (LP-WUR) 434 included in the initiating device 422 during the FTM service session.

The LP-WUR 434 may use simple modulation schemes such as on-off keying (OOK), amplitude shift keying (ASK), or frequency shift keying (FSK) for signaling. The LP-WUR 434 may use hardware and/or software components that may allow it to operate at a lower power consumption mode than a typical radio component (e.g., 802.11 devices 436 and 438).

The LP-WUR 434 may be constantly active (e.g., ON state 440) on the initiating device 422 in order to receive a wake-up communication (e.g., the wake-up packet 432). The responding device 402 may begin transmitting the wake-up packet 432 using a low-power communication method. The LP-WUR 434 may detect and/or decode the wake-up packet and may determine whether the wake-up packet is destined for the initiating device 422. If the LP-WUR 434 (or other portions of the initiating device 422) determines that the receiver address (RA) field of the MAC header from the wake-up packet 432 matches the address of the initiating device 422, the LP-WUR 434 may then send a signal to the 802.11 radio 436 to power on (e.g., ON/OFF state 442) its circuitry.

The wake-up packet 432 may include timing information such as a wake-up period. The wake-up period may be a period of time that the initiating device 422 may need to have when devices, such as the responding device 402, may be sending data to the initiating device 422. Following the wake-up period, the initiating device 422 may power off some or all of its circuitry to reduce power consumption and preserve the life of its battery. The wake-up packet 432 may also include information to notify the initiating device 422 of the upcoming FTM frame(s) 444 that may be received from the responding device 402 during the FTM session in order to perform the timing measurements.

The low-power wake-up transmitter 430 may be a device on the responding device 402 that transmits a wake-up packet to other devices (e.g., the initiating device 422). The low-power wake-up transmitter 430 may transmit at the same simple modulation schemes of the initiating device 422 (e.g., OOK, ASK, FSK, etc.). The low-power wake-up transmitter 430 may utilize signaling in order to generate and transmit the wake-up packet 432. This may allow the FTM procedure to move from sending data to signaling, which may also provide advantages such as processing time on the responding device 402 and/or the initiating device 422.

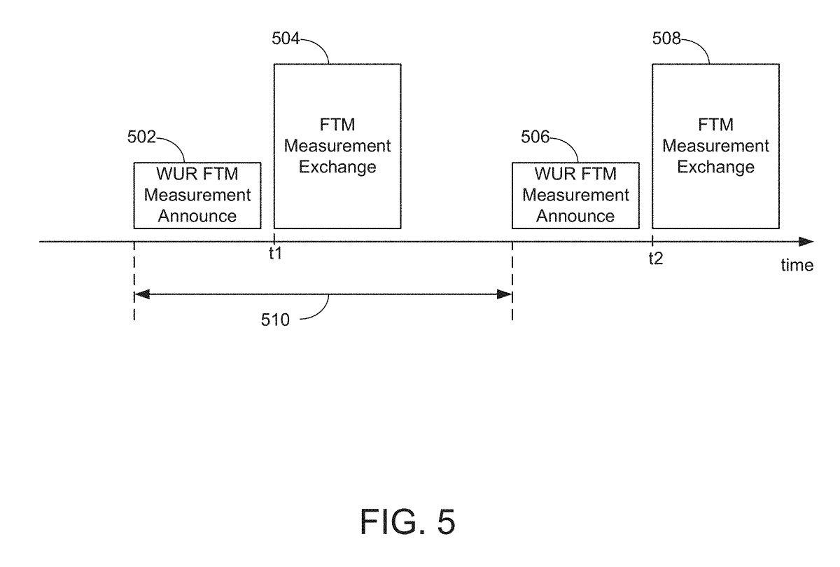

FIG. 5 depicts an illustrative schematic diagram of an FTM measurement period, in accordance with one or more example embodiments of the present disclosure.

Referring to FIG. 5, there is shown multiple transmissions including, but not limited to, a WUR FTM measurement announce indication 502 (e.g., a message, a frame, a bit, a signal, a wave, etc.), an FTM measurement exchange 504, a WUR FTM measurement announce indication 506, and an FTM measurement exchange 508. These transmissions may be exchanged between two devices, such as a responding device and an initiating device during an FTM session. The WUR FTM measurement announce indications 502 and 506 may be in the form of a wake-up packet sent from a responding device to an initiating device. The WUR FTM measurement announce indications 502 and 506 may be sent to inform the initiating device of upcoming FTM frame(s) that may be sent to the initiating device as part of the FTM procedure. The initiating device may utilize the WUR FTM measurement announce indications 502 and 506 in order to perform additional actions on the initiating device, such as powering up/down one or more of its circuitry based on information included in the WUR FTM measurement announce indications 502 and 506. The WUR FTM measurement announce indications 502 and 506 may include information associated with one or more FTM frames during the FTM procedure. The WUR FTM measurement announce indications 502 and 506 may include timing information associated with the FTM procedure. For example, the WUR FTM measurement announce indication 502 may include a predetermined time (e.g., t1) that the initiating device may expect to receive an FTM frame. Similarly, the WUR FTM measurement announce indication 506 may include a predetermined time (e.g., t2) that the initiating device may expect to receive a second FTM frame. The wake-up packet may include the agreed and expected periodic expectation of additional FTM frames and/or wake-up packets. Additionally, the WUR FTM measurement announce indications 502 and 506 may be expected to be sent periodically (e.g., period 510) by a responding device during a burst duration and/or a burst period of an FTM session. It is understood that the above descriptions are for purposes of illustration and are not meant to be limiting.

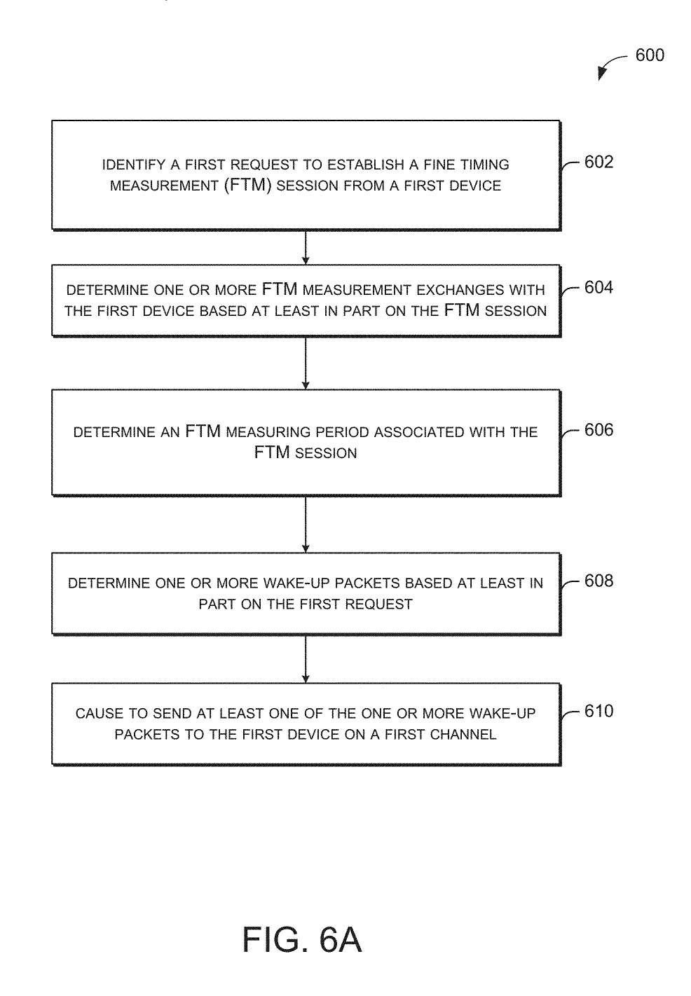

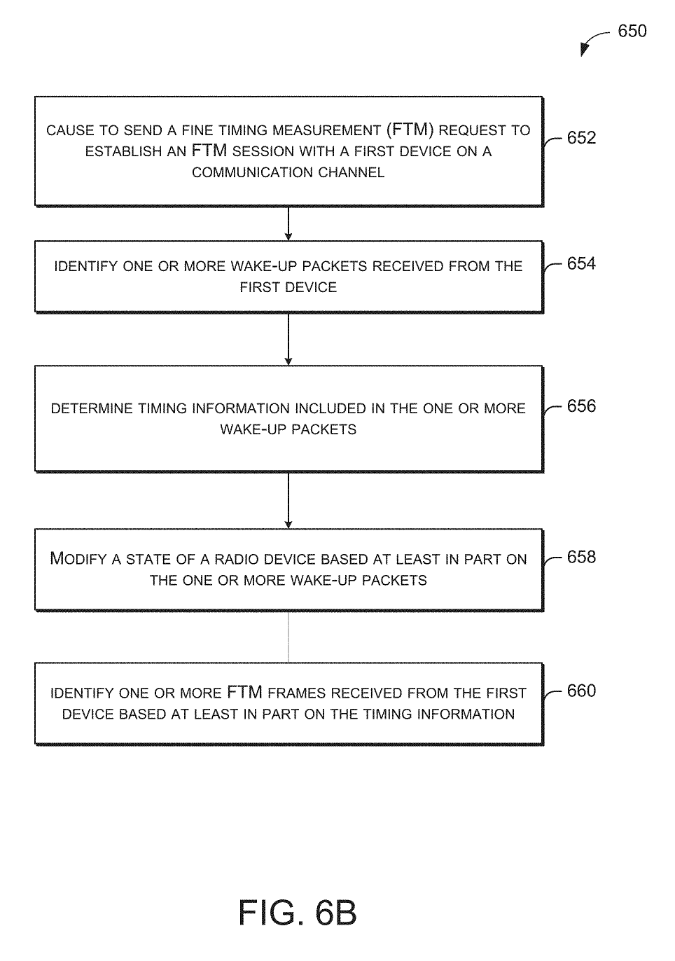

FIG. 6A illustrates a flow diagram of illustrative process 600 for FTM signaling, in accordance with one or more embodiments of the disclosure.

At block 602, a responding device (e.g., the RD 102 of FIG. 1) may determine a first request to establish a fine timing measurement (FTM) session from an initiating device (e.g., a user device 120 of FIG. 1). A responding device may support location determination of an initiating device (e.g., the user device 120 of FIG. 1) based on range measurements. Range measurements may include determining propagation timing of one or more FTM frames sent to the initiating device during a burst duration associated with the FTM session. For example, the FTM procedure may determine the location of an initiating device (also known as a positioning device) based on time differences between various FTM frames sent and received between the initiating device and a responding device. The FTM session may support location determination of the initiating device based on the range measurement.

At block 604, the responding device may determine one or more FTM measurement exchanges with the first device based at least in part on the FTM session. The one or more FTM measurement exchanges may be associated with sending one or more sets of FTM frames during one or more burst periods. For example, during a first burst period, the responding device may send a first set of FTM frames to determine the range measurements with the initiating device. In a second burst period, the responding device may send a second set of FTM frames to determine the range measurements with the initiating device.

At block 606, the responding device may determine an FTM measuring period associated with the FTM session. The FTM measuring period may be referred to as a burst period. The burst period also may be associated with a burst duration. The burst duration may be a duration of each burst instance starting at the boundary of a burst period. That is, the burst duration may be a time duration within which one or more FTM frames may be sent to the initiating device. The burst period may be an interval from the beginning of one burst instance to the beginning of the following burst instance.

At block 608, the responding device may determine one or more wake-up packets based at least in part on the first request. A wake-up packet may be an indication that the radio system of the initiating device may need to be powered on in order to start receiving/sending data associated with the FTM session. The wake-up packet may include information associated with the FTM frame during the FTM session. For example, the wake-up packet may include timing information associated with the FTM session. For example, the wake-up packet may include a time when an FTM frame may be sent and/or received by the initiating device. The wake-up packet may include an agreed and expected periodic expectation of additional wake-up packets. That is, the wake-up packets may be expected to be sent periodically by a responding device during a burst duration and/or a burst period.

At block 610, the responding device may cause to send at least one of the one or more wake-up packets to the initiating device on a communication channel. The responding device may include a wake-up packet transmitter that may generate a wake-up packet to be transmitted to the initiating device during the FTM session. It is understood that the above descriptions are for purposes of illustration and are not meant to be limiting.

FIG. 6B illustrates a flow diagram of illustrative process 650 for FTM signaling, in accordance with one or more embodiments of the disclosure.

At block 652, an initiating device (e.g., the user device 120 of FIG. 1) may send an FTM request to establish an FTM session with a first device (e.g., the RD 102 of FIG. 1) on a communication channel. The initiating device may simultaneously (or at different times) initiate a number of FTM sessions with multiple responding devices. The multiple responding devices may be operating at different channels and may not be synchronized with each other in order to minimize collisions. Consequently, the initiating device may have more than one ongoing FTM session instance at any given time as well as other activities asynchronous in nature to the FTM procedure on other channels.

At block 654, the initiating device may identify one or more wake-up packets received from the responding device. After the negotiating portion of the FTM session, the initiating device may expect to receive one or more FTM frames as part of the FTM session. An LP-WUR integrated in the circuitry of the initiating device may be configured to receive a wake-up packet as an indication that the radio system of the initiating device may need to be powered on in order to start receiving/sending data associated with the FTM procedure. The LP-WUR may be based on “on-off Keying” (OOK) and may be characterized with a much lower power consumption compared to a normal IEEE 802.11 OFDM receiver (e.g., an IEEE 802.11 receiver). The responding device may include a wake-up packet transmitter that generates a wake-up packet to be transmitted to the initiating device during the FTM procedure. The LP-WUR may improve the FTM procedure by eliminating the need for a trigger frame transmission by the initiating device and may have the responding device transmit a wake-up packet prior to transmission of the FTM frames. The wake-up packet may be transmitted by the responding device using a wake-up packet transmitter and may be received by the LP-WUR of the initiating device.

At block 656, the initiating device may determine timing information included in the one or more wake-up packets. For example, the LP-WUR may extract the timing information from at least one of the one or more wake-up packets. The one or more wake-up packets may indicate that the radio system of the initiating device may need to be powered on in order to start receiving/sending data associated with the FTM session. Based on but not limited to that information, the LP-WUR may generate a signal to be sent to a radio device including radio circuitry in the initiating device. The signal may be a wake-up signal that indicates to the radio device to power itself on or off based on the information included in the wake-up packet. Further, the one or more wake-up packets may include an agreed and expected periodic expectation of additional wake-up packets. That is, the wake-up packets may be expected to be sent periodically by a responding device during a burst duration and/or a burst period.

At block 658, the initiating device may modify a state of a radio device based at least in part on the one or more wake-up packets. For example, the initiating device may determine that one of the one or more wake-up packets indicates that the initiating device should power its radio device on, in preparation for receiving at least one FTM frame from the responding device. For example, the LP-WUR may generate the wake-up signal and send it to the radio device, instructing it to power itself on. When the radio device is powered on, it may be able to receive the one or more FTM frames that may be sent by the responding device to the initiating device.

At block 660, the initiating device may identify one or more FTM frames received from the responding device based at least in part on the timing information. The timing information may include a start time of the FTM frames that will indicate to the initiating device when to expect to receive the one or more FTM frames. It is understood that the above descriptions are for purposes of illustration and are not meant to be limiting.

FIG. 7 shows a functional diagram of an exemplary communication station 700 in accordance with some embodiments. In one embodiment, FIG. 7 illustrates a functional block diagram of a communication station that may be suitable for use as an RD 102 (FIG. 1) or a user device 120 (FIG. 1) in accordance with some embodiments. The communication station 700 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 700 may include communications circuitry 702 and a transceiver 710 for transmitting and receiving signals to and from other communication stations using one or more antennas 701. The communications circuitry 702 may include circuitry that can operate the physical layer communications and/or medium access control (MAC) communications for controlling access to the wireless medium, and/or any other communications layers for transmitting and receiving signals. The communication station 700 may also include processing circuitry 706 and memory 708 arranged to perform the operations described herein. In some embodiments, the communications circuitry 702 and the processing circuitry 706 may be configured to perform operations detailed in FIGS. 1-6B.

In accordance with some embodiments, the communications circuitry 702 may be arranged to contend for a wireless medium and configure frames or packets for communicating over the wireless medium. The communications circuitry 702 may be arranged to transmit and receive signals. The communications circuitry 702 may also include circuitry for modulation/demodulation, upconversion/downconversion, filtering, amplification, etc. In some embodiments, the processing circuitry 706 of the communication station 700 may include one or more processors. In other embodiments, two or more antennas 701 may be coupled to the communications circuitry 702 arranged for sending and receiving signals. The memory 708 may store information for configuring the processing circuitry 706 to perform operations for configuring and transmitting message frames and performing the various operations described herein. The memory 708 may include any type of memory, including non-transitory memory, for storing information in a form readable by a machine (e.g., a computer). For example, the memory 708 may include a computer-readable storage device, read-only memory (ROM), random-access memory (RAM), magnetic disk storage media, optical storage media, flash-memory devices and other storage devices and media.

In some embodiments, the communication station 700 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 700 may include one or more antennas 701. The antennas 701 may include one or more directional or omnidirectional antennas including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 700 may include one or more of a keyboard, a display, a non-volatile memory port, multiple antennas, a graphics processor, an application processor, speakers, and other mobile device elements. The display may be an LCD screen including a touch screen.

Although the communication station 700 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs), and combinations of various hardware and logic circuitry for performing at least the functions described herein. In some embodiments, the functional elements of the communication station 700 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 700 may include one or more processors and may be configured with instructions stored on a computer-readable storage device memory.

FIG. 8 illustrates a block diagram of an example of a machine 800 or system upon which any one or more of the techniques (e.g., methodologies) discussed herein may be performed. In other embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environments. The machine 800 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a power management device 832, a graphics display device 810, an alphanumeric input device 812 (e.g., a keyboard), and a user interface (UI) navigation device 814 (e.g., a mouse). In an example, the graphics display device 810, the alphanumeric input device 812, and the UI navigation device 814 may be a touch screen display. The machine 800 may additionally include a storage device (i.e., drive unit) 816, a signal generation device 818 (e.g., a speaker), an FTM signaling device 819, a network interface device/transceiver 820 coupled to antenna(s) 830, and one or more sensors 828, such as a global positioning system (GPS) sensor, a compass, an accelerometer, or other sensor. The machine 800 may include an output controller 834, such as a serial connection (e.g., universal serial bus (USB), parallel, or other wired or wireless connection (e.g., infrared (IR), near field communication (NFC), etc.) to communicate with or control one or more peripheral devices (e.g., a printer, a card reader, etc.)).

The storage device 816 may include a machine-readable medium 822 on which is stored one or more sets of data structures or instructions 824 (e.g., software) embodying or utilized by any one or more of the techniques or functions described herein. The instructions 824 may also reside, completely or at least partially, within the main memory 804, within the static memory 806, or within the hardware processor 802 during execution thereof by the machine 800. In an example, one or any combination of the hardware processor 802, the main memory 804, the static memory 806, or the storage device 816 may constitute machine-readable media.

The FTM signaling device 819 may carry out or perform any of the operations and processes (e.g., processes 600 and 650) described and shown above. For example, the FTM signaling device 819 may be configured to add a low-power wake-up receiver (LP-WUR) to an initiating device to wake up the main radio system (e.g., an IEEE 802.11 radio) within the initiating device based on receiving a wake-up packet from a responding device during an FTM procedure. The LP-WUR integrated in the circuitry of the initiating device may be configured to receive a wake-up packet as an indication that the radio system of the initiating device may need to be powered on in order to start receiving/sending data associated with the FTM procedure. The LP-WUR may be based on “on-off Keying” (OOK) and may be characterized with a much lower power consumption compared to a normal IEEE 802.11 OFDM receiver (e.g., an IEEE 802.11 receiver). The responding device may include a wake-up packet transmitter that generates a wake-up packet to be transmitted to the initiating device during the FTM procedure.

The FTM signaling device 819 may be configured to utilize the LP-WUR to improve the FTM procedure by eliminating the need for a trigger frame transmission by the initiating device and may have the responding device transmit an indication (e.g., a wake-up packet) prior to transmission of one or more FTM measurement frames. The indication may be transmitted by the responding device using the wake-up packet transmitter and may be received by the LP-WUR of the initiating device. Consequently, power consumption may be lowered by implementing the LP-WUR, which may prevent the initiating device from utilizing excess power due to trigger frame transmission because incoming FTM measurement frames are initiated by the initiating device using the trigger frame.

The FTM signaling device 819 may be configured to include information associated with the FTM frame during the FTM procedure in the wake-up packet. For example, the wake-up packet may include timing information associated with the FTM procedure. For example, the wake-up packet may include a time when an FTM frame may be sent and/or received by the initiating device. The wake-up packet may include an agreed and expected periodic expectation of additional wake-up packets. That is, the wake-up packets may be expected to be sent periodically by a responding device during a burst duration and/or a burst period.

The FTM signaling device 819 may be configured to use the LP-WUR on the initiating device to allow for more accurate TOF (Time of Flight) measurement based on FTM measurement frames that are transmitted during pre-negotiated time windows. Since the FTM procedure is targeted to support location determination based on range measurement to multiple known responding devices and execution of trilateration, the FTM procedure is capable of operating in both the associated and unassociated modes; that is, when a device (e.g., an initiating device) is associated with a responding device or is unassociated with the responding device. These time windows may be made by asynchronous APs deployed over different channels. Furthermore, the initiating device may have other asynchronous and non-periodic activities such as data connectivity to one of these APs or another AP.

While the machine-readable medium 822 is illustrated as a single medium, the term “machine-readable medium” may include a single medium or multiple media (e.g., a centralized or distributed database, and/or associated caches and servers) configured to store the one or more instructions 824.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random access memory (RAM), magnetic disk storage media, optical storage media, a flash memory, etc.

The term “machine-readable medium” may include any medium that is capable of storing, encoding, or carrying instructions for execution by the machine 800 and that cause the machine 800 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device/transceiver 820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone service (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 820 may include one or more physical jacks (e.g., Ethernet, coaxial, or phone jacks) or one or more antennas to connect to the communications network 826. In an example, the network interface device/transceiver 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800 and includes digital or analog communications signals or other intangible media to facilitate communication of such software. The operations and processes (e.g., processes 600 and 650) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device,” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one-way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM evolution (EDGE), or the like. Other embodiments may be used in various other devices, systems, and/or networks.

According to example embodiments of the disclosure, there may be a device. The device may include at least one memory that stores computer-executable instructions, and at least one processor of the one or more processors configured to access the at least one memory, wherein the at least one processor of the one or more processors is configured to execute the computer-executable instructions to first device. The at least one processor of the one or more processors may be configured to execute the computer-executable instructions to determine one or more FTM measurement exchanges with the first device based at least in part on the FTM session. The at least one processor of the one or more processors may be configured to execute the computer-executable instructions to determine an FTM measuring period associated with the FTM session. The at least one processor of the one or more processors may be configured to execute the computer-executable instructions to determine one or more wake-up packets based at least in part on the first request. The at least one processor of the one or more processors may be configured to execute the computer-executable instructions to cause to send at least one of the one or more wake-up packets to the first device on a first channel.

The implementations may include one or more of the following features. The FTM measurement exchanges include one or more FTM frames sent to the first device within the FTM measuring period. The FTM measuring period may include one or more time durations for sending the one or more FTM frames to the first device. At least one of the one or more wake-up packets is associated with at least one of the FTM measurement exchanges. The one or more wake-up packets are sent periodically to the first device. The wake-up packet contains, at least in part, timing information associated with waking up radio circuitry on the first device. The timing information may include, at least in part, a start time of at least one of the one or more FTM measurement exchanges. the wake-up packet is compliant with at least one of an on-off keying (OOK) modulation scheme, an amplitude shift keying (ASK) modulation scheme, or a frequency shift keying (FSK) modulation scheme. The device may further include a transceiver configured to transmit and receive wireless signals. The device may further include one or more antennas coupled to the transceiver.

According to example embodiments of the disclosure, there may be a non-transitory computer-readable medium storing computer-executable instructions which, when executed by a processor, cause the processor to perform operations. The operations may include causing to send a fine timing measurement (FTM) request to establish an FTM session with a first device on a communication channel. The operations may include identifying one or more wake-up packets received from the first device. The operations may include determining timing information included in the one or more wake-up packets. The operations may include modifying a state of a radio device based at least in part on the one or more wake-up packets. The operations may include identifying one or more FTM frames received from the first device based at least in part on the timing information.

The implementations may include one or more of the following features. The operations for modifying a state of the radio device further include the operations for powering on the radio device or powering off the radio device. At least one of the one or more wake-up packets is associated with at least one of FTM measurement exchanges. The FTM measurement exchanges include one or more FTM frames received within an FTM measuring period associated with the FTM session. The one or more wake-up packets are received periodically. the wake-up packet is compliant with at least one of an on-off keying (OOK) modulation scheme, an amplitude shift keying (ASK) modulation scheme, or a frequency shift keying (FSK) modulation scheme.

In example embodiments of the disclosure, there may be an apparatus. The apparatus may include means for identifying a first request to establish a fine timing measurement (FTM) session from a first device. The apparatus may include means for determining one or more FTM measurement exchanges with the first device based at least in part on the FTM session. The apparatus may include means for determining an FTM measuring period associated with the FTM session. The apparatus may include means for determining one or more wake-up packets based at least in part on the first request. The apparatus may include means for causing to send at least one of the one or more wake-up packets to the first device on a first channel.

Implementations may include one or more of the following features. The FTM measurement exchanges include one or more FTM frames sent to the first device within the FTM measuring period. The FTM measuring period includes one or more time durations for sending the one or more FTM frames to the first device. At least one of the one or more wake-up packets is associated with at least one of the FTM measurement exchanges. The wake-up packet contains, at least in part, timing information associated with waking up radio circuitry on the first device. The timing information includes, at least in part, a start time of at least one of the one or more FTM measurement exchanges.

In example embodiments of the disclosure, there may be an apparatus. The apparatus may include means for causing to send a fine timing measurement (FTM) request to establish an FTM session with a first device on a communication channel. The apparatus may include means for identifying one or more wake-up packets received from the first device. The apparatus may include means for determining timing information included in the one or more wake-up packets. The apparatus may include means for modifying a state of a radio device based at least in part on the one or more wake-up packets. The apparatus may include means for identifying one or more FTM frames received from the first device based at least in part on the timing information.

Implementations may include one or more of the following features. The operations comprising means for modifying a state of the radio device further include the operations comprising means for powering on the radio device or powering off the radio device. At least one of the one or more wake-up packets is associated with at least one of FTM measurement exchanges. The FTM measurement exchanges include one or more FTM frames received within an FTM measuring period associated with the FTM session. The one or more wake-up packets are received periodically. the wake-up packet is compliant with at least one of an on-off keying (OOK) modulation scheme, an amplitude shift keying (ASK) modulation scheme, or a frequency shift keying (FSK) modulation scheme.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor configured to access the at least one memory, wherein the at least one processor is configured to execute the computer-executable instructions to:
determine a first request to establish a fine timing measurement (FTM) session from a first device;
determine one or more FTM measurement exchanges with the first device based at least in part on the FTM session;
determine an FTM measuring period associated with the FTM session;
determine one or more wake-up packets based at least in part on the first request; and
cause to send at least one of the one or more wake-up packets to the first device on a first channel.

2. The device of claim 1, wherein the FTM measurement exchanges include one or more FTM frames sent to the first device within the FTM measuring period.

3. The device of claim 2, wherein the FTM measuring period includes one or more time durations for sending the one or more FTM frames to the first device.

4. The device of claim 1, wherein at least one of the one or more wake-up packets is associated with at least one of the FTM measurement exchanges.

5. The device of claim 1, wherein the one or more wake-up packets are sent periodically to the first device.

6. The device of claim 1, wherein the wake-up packet contains, at least in part, timing information associated with waking up radio circuitry on the first device.

7. The device of claim 6, wherein the timing information includes, at least in part, a start time of at least one of the one or more FTM measurement exchanges.

8. The device of claim 1, wherein the wake-up packet is compliant with at least one of an on-off keying (OOK) modulation scheme, an amplitude shift keying (ASK) modulation scheme, or a frequency shift keying (FSK) modulation scheme.

9. The device of claim 1, further comprising a transceiver configured to transmit and receive wireless signals.

10. The device of claim 9, further comprising one or more antennas coupled to the transceiver.

11. A non-transitory computer-readable medium storing computer-executable instructions which when executed by one or more processors result in performing operations comprising:
causing to send a fine timing measurement (FTM) request to establish an FTM session with a first device on a communication channel;
identifying one or more wake-up packets received from the first device;
determining timing information included in the one or more wake-up packets;
modifying a state of a radio device based at least in part on the one or more wake-up packets; and
identifying one or more FTM frames received from the first device based at least in part on the timing information.

12. The non-transitory computer-readable medium of claim 11, wherein the operations for modifying a state of the radio device further include the operations for powering on the radio device or powering off the radio device.

13. The non-transitory computer-readable medium of claim 11, wherein at least one of the one or more wake-up packets is associated with at least one of FTM measurement exchanges.

14. The non-transitory computer-readable medium of claim 13, wherein the FTM measurement exchanges include one or more FTM frames received within an FTM measuring period associated with the FTM session.

15. The non-transitory computer-readable medium of claim 13, wherein the one or more wake-up packets are received periodically.

16. The non-transitory computer-readable medium of claim 11, wherein the wake-up packet is compliant with at least one of an on-off keying (OOK) modulation scheme, an amplitude shift keying (ASK) modulation scheme, or a frequency shift keying (FSK) modulation scheme.

17. A method comprising:
identifying a first request to establish a fine timing measurement (FTM) session from a first device;
determining one or more FTM measurement exchanges with the first device based at least in part on the FTM session;
determining an FTM measuring period associated with the FTM session;
determining one or more wake-up packets based at least in part on the first request; and
causing to send at least one of the one or more wake-up packets to the first device on a first channel.

18. The method of claim 17, wherein the wake-up packet is compliant with at least one of an on-off keying (OOK) modulation scheme, an amplitude shift keying (ASK) modulation scheme, or a frequency shift keying (FSK) modulation scheme.

19. The method of claim 17, wherein the FTM measurement exchanges include one or more FTM frames sent to the first device within the FTM measuring period.

20. The method of claim 19, wherein the FTM measuring period includes one or more time durations for sending the one or more FTM frames to the first device.
